(19) United States
(12) Patent Application Publication
(10) Pub. No.: US 2024/0177131 A1
(43) Pub. Date: May 30, 2024

(54) Devices, Systems, and Methods for Automated Weight Measuring and Inventory Management of Consumer Goods

(71) Applicant: ZEBRA TECHNOLOGIES CORPORATION, Lincolnshire, IL (US)

(72) Inventors: Karthikeyan Nagarajan, Chennai (IN); Alessandro Bay, London (GB)

(21) Appl. No.: 18/072,173

(22) Filed: Nov. 30, 2022

(51) Int. Cl. G06Q 20/20; G06V 10/82; G06V 20/60

(52) U.S. Cl. CPC G06Q 20/208; G06V 10/82; G06V 20/60

(57) ABSTRACT

Devices, systems, and methods for weight-based tracking and pricing of consumer goods. The devices, systems, and methods may include detecting, by a scale device, a first change in weight of a display area; capturing, by a first imaging camera, a first image featuring the display area; detecting, by one or more processors, a first object in the first image; identifying, by the one or more processors, the first object; associating, by the one or more processors, the detected first change in weight with the identified first object to determine a transaction value associated with the identified first object based upon the detected first change in weight; and displaying, by a display device, a rendition of the display area, the rendition containing a representation of the first object and the transaction value.

### BACKGROUND

Traditionally, produce aisles of grocery stores sell their goods by the pound. However, unpackaged produce are typically not weighed by the seller. If a customer selects one or more produce goods (e.g., 3 bananas), they must weigh those goods themselves (e.g., to learn that the 3 bananas weigh 2.67 pounds), and then they must calculate the price of the goods based on the displayed pricing (e.g., $1.20 USD per pound for a total of $3.20 USD) to determine the total price of their selection before checkout.

A similar issue occurs at the delicatessen sections of grocery stores. While packaged meats might be weighed by the seller, customers often purchase slices or portions of meat from the seller. Further, the seller may present slices and/or portions of meat on display for the customer without first measuring the weight of the slices/portions. In these instances, the customer often must ask for assistance from a member of staff to (i) select a meat, (ii) cut desired slices/portions of the meat, (iii) measure the slices/portions, and/or (iii) calculate the value of the slices/portions on the customer's behalf.

As such, purchasing meat and/or produce can be time consuming and cumbersome for customers.

### SUMMARY

Provided herein are devices, systems, and methods for the automated weight measuring and inventory management of consumer goods. One or more smart display stations may house electronic scale(s), and one or more consumer goods may be placed atop the one or more smart display stations. The one or more smart display stations, in connection with the electronic scale(s), may accurately measure the weight of the one or more consumer goods.

One or more cameras may monitor the one or more smart display stations and may be triggered to capture one or more images of the one or more smart display stations when the electronic scales detect changes in weight, when the one or more cameras sense objects enter their field of view, etc. In another aspect, the one or more cameras may continuously capture one or more images of the one or more smart display stations (e.g., via a video recording, a real-time video stream, a real-time video broadcast, etc.) and one or more images may be selected by either the one or more cameras and/or a processing server when a change in weight is detected, when an object enters a field of view, etc.

The one or more consumer goods may be added onto and/or removed from the one or more smart display stations. Whenever one or more consumer goods are added to and/or removed from one of the smart display stations, the smart display station and/or the one or more cameras may operate and/or interact with each other and/or the processing server.

The processing server may identify and/or recognize the consumer good(s) added to and/or removed from the smart display station(s); measure the weight of those consumer good(s); calculate and/or estimate the transaction value of the consumer good(s); generate a rendition of the smart display station to be displayed on a display unit featuring: the consumer good(s), identifying information of the consumer goods, the measured weight of the consumer good(s), and/or the calculated and/or estimated transaction value of the consumer good(s); update an inventory list of the store; update the store's profits; and/or perform some other form of processing and/or analysis of the one or more images.

In some embodiments, a method is provided for automated weight measuring and inventory management of consumer goods. The method may be implemented via one or more local or remote processors, memory units, transceivers, sensors, networks, servers, and/or other electronic or electrical components. In one instance, the method may include: (1) detecting, by a scale device, a first change in weight of a display area; (2) capturing, by a first imaging camera, a first image featuring the display area; (3) detecting, by one or more processors, a first object in the first image; (4) identifying, by the one or more processors, the first object; (5) associating, by the one or more processors, the detected first change in weight with the identified first object to determine a transaction value associated with the identified first object based upon the detected first change in weight; and (6) displaying, by a display device, a rendition of the display area, the rendition containing a representation of the first object and the transaction value.

Advantages will become more apparent to those of ordinary skill in the art from the following description of the preferred embodiments, which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1A depicts exemplary components, devices, and apparatuses used by devices and systems for automated weight measuring and inventory management of consumer goods;

FIG. 1B depicts exemplary devices and systems including a smart display station for automated weight measuring and inventory management of consumer goods;

FIG. 1C depicts exemplary devices and systems including a smart display station, cameras, a display unit, and a processing server for automated weight measuring and inventory management of consumer goods;

FIG. 2 depicts an exemplary environment including components and apparatuses for automated weight measuring and inventory management of consumer goods;

FIG. 3 depicts an exemplary flowchart representative of example methods, hardware logic, and instructions for implementing the automated weight measuring and inventory management of consumer goods; and

FIG. 4 depicts an exemplary method for automated weight measuring and inventory management of consumer goods.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

### Exemplary Computing Components, Apparatuses and Devices

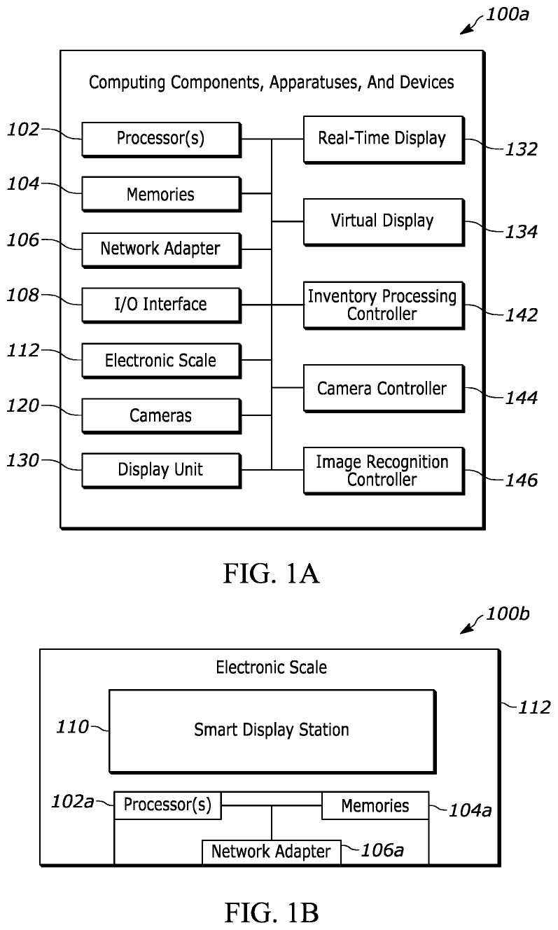

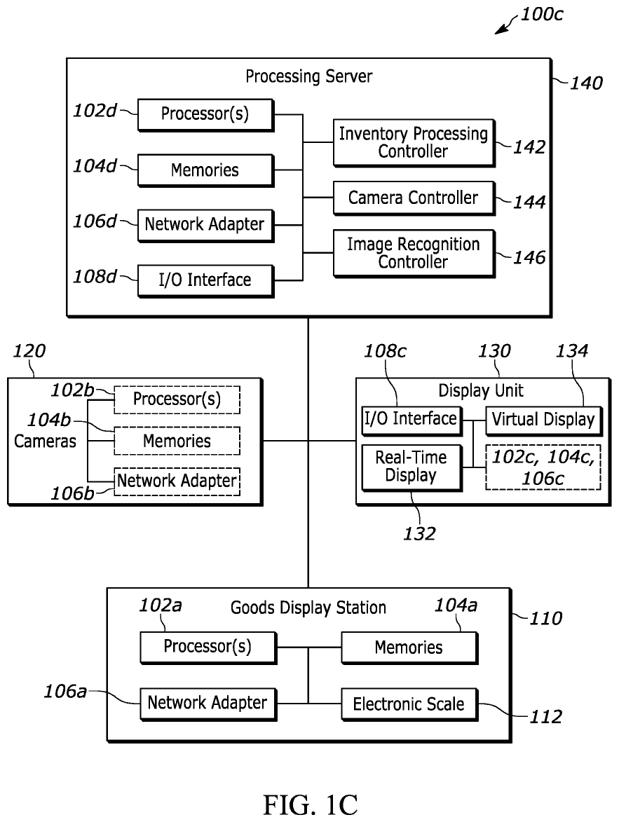

FIG. 1A depicts a diagram of exemplary computing components, apparatuses, and devices 100a that may be used in devices and/or systems for automated weight measuring and inventory management of consumer goods. The exemplary computing components, apparatuses, and devices 100a may include one or more processors 102, one or more memories 104, one or more network adapters 106, one or more electronic scales 112, one or more cameras 120, one or more display units 130, one or more I/O interfaces 108, one or more real-time displays 132, one or more virtual displays 134, one or more inventory processing controllers 142, one or more camera controllers 144, one or more image recognition controllers 146.

The one or more processors 102 may be, or may include, a central processing unit (CPU), a graphical processing unit (GPU), a digital signal processor (DSP), an application specific integrated circuit (ASIC), a programmable logic device (PLD), a field-programmable gate array (FPGA), a field-programmable logic device (FPLD), etc.

The one or more memories 104 may be, or may include, any local short term memory (e.g., random access memory (RAM), read only memory (ROM), cache, etc.) and/or any long term memory (e.g., hard disk drives (HDD), solid state drives (SSD), etc.).

The one or more network adapters 106 may be, or may include, a wired network adapter, connector, interface, etc. (e.g., an Ethernet network connector, an asynchronous transfer mode (ATM) network connector, a digital subscriber line (DSL) modem, a cable modem) and/or a wireless network adapter, connector, interface, etc. (e.g., a Wi-Fi connector, a Bluetooth® connector, an infrared connector, a cellular connector, etc.).

The one or more electronic scales 112 may be, or may include, any digital and/or electronic analog scale that measures the weight of an object with mass.

The one or more cameras 120 may be, or may include, any camera device that may capture one or more images (e.g., a film image camera, a digital image camera, a film video camera, a digital video camera, a broadcasting camera, a streaming camera, camera units of computing devices, etc.).

The one or more display units 130 may be, or may include any audio and/or visual output display (e.g., a speaker, a liquid crystal display (LCD), a cathode ray tube (CRT) display, touch screen display, etc.).

The one or more I/O interfaces 108 may be, or may include, any number of different types of I/O units and/or combined I/O circuits and/or I/O components that enable the one or more processors 102 of the transaction processing station 110 to communicate with peripheral devices. The peripheral devices may be a display unit 130 and/or any input device such as a keyboard, a navigation device (a mouse, a trackball, a capacitive touch pad, a joystick, etc.), a microphone, a button, etc. a communication interface, an antenna, etc.

The one or more real-time displays 132 may be, or may include, one or more images captured by the one or more cameras 120 presented in real-time on the one or more display units 130.

The one or more virtual displays 134 may be, or may include, one or more simulated representations of the one or more images captured by the one or more cameras 120 that are updated in real-time and presented in real-time on the one or more display units 130.

The one or more inventory processing controllers 142, the one or more camera controllers 144, and/or the image recognition controllers 146 may be, or may include, computer-readable, executable instructions that may be stored in the one or more memories 104 and/or performed by the one or more processors 102. Further, the computer-readable, executable instructions of the one or more inventory processing controllers 142, the one or more camera controllers 144, and/or the image recognition controllers 146 may be stored on and/or performed by specifically designated hardware (e.g., micro controllers, microchips, etc.) which may have functionalities similar to the one or more memories 104 and/or the one or more processors 102.

### Exemplary Devices and Systems

FIGS. 1B and 1C depict diagrams of exemplary devices and systems 100b and 100c, respectfully, to perform automated weight measuring and inventory management of consumer goods.

The exemplary devices and systems 100b of FIG. 1B may include one or more smart display stations 110. The one or more smart display stations 110 may include one or more processors 102a, one or more memories 104a, and/or a network adapter 106a.

The one or more memories 104a and/or the network adapter 106a of the one or more smart display stations 110 may be coupled to the one or more processors 102a of the one or more smart display stations 110 via any omnibus. While only the one or more processors 102a, the one or more memories 104a, and/or the network adapter 106a of the one or more smart display stations 110 are described herein, additional and/or alternative components of the one or more smart display stations 110 are contemplated.

The exemplary devices and systems 100c of FIG. 1C may include the one or more smart display stations 110, one or more cameras 120, one or more display units 130, and/or a processing server 140.

In some embodiments, the one or more cameras 120 may include one or more processors 102b, one or more memories 104b, and/or a network adapter 106b.

In these embodiments, the one or more memories 104b and/or the network adapter 106b of the one or more cameras 120 may be coupled to the one or more processors 102b of the one or more cameras 120 via any omnibus. While only the one or more processors 102b, the one or more memories 104b, and/or the network adapter 106b of the one or more cameras 120 are described herein, additional and/or alternative components of the one or more cameras 120 are contemplated (such as an I/O interface 108).

In some embodiments, the one or more display units 130 may include one or more processors 102c, one or more memories 104c, a network adapter 106c, an I/O interface 108c, one or more real-time displays 132, and/or one or more virtual displays 134.

In these embodiments, the one or more memories 104c and/or the network adapter 106c of the one or more display units 130 may be coupled to the one or more processors 102c of the one or more display units 130 via any omnibus. The one or more display units 130 may display the one or more real-time displays 132 and/or the one or more virtual displays 134. The one or more real-time displays 132 and/or the one or more virtual displays 134 may be generated from the one or more images captured by the one or more cameras 120. While only the one or more processors 102c, the one or more memories 104c, the network adapter 106c, the one or more real-time displays 132, and/or the one or more virtual displays 134 of the one or more display units 130 are described herein, additional and/or alternative components of the one or more display units 130 are contemplated.

The processing server 140 may include one or more processors 102d, one or more memories 104d, a network adapter 106d, an I/O interface 108d, an inventory processing controller 142, a camera controller 144, and/or an image recognition controller 146.

The one or more memories 104d, the network adapter 106d, the I/O interface 108d, the inventory processing controller 142, the camera controller 144, and/or the image recognition controller 146 of the processing server 140 may be coupled to the one or more processors 102d of the processing server 140 and/or with each other via any omnibus. While only the one or more processors 102d, the one or more memories 104d, the network adapter 106d, the I/O interface 108d, the inventory processing controller 142, the camera controller 144, and/or the image recognition controller 146 of the processing server 140 are described herein, additional and/or alternative components of the processing server 140 are contemplated.

In some embodiments, the one or more smart display stations 110, the one or more cameras 120, the one or more display units 130 and/or the processing server 140 are coupled together to form a closed circuit system. In these embodiments, the one or more smart display stations 110 function as external components to the processing server 140 and any detections, determinations, and/or measurements made by the smart display stations 110 and/or their components are made by the one or more processors 102d of the processing server 140 and the results of those detections, determinations, and/or measurements are stored in the one or more memories 104d of the processing server. Similarly, the one or more cameras 120 are a camera unit of the processing server and any images captured by the one or more cameras are stored in the one or more memories 104d of the processing server 140. Similar still, the one or more display units 130 also function as external components to the processing server 140 with any output made by the processing server 140 being output to the one or more display units 130.

In some other embodiments, the one or more smart display stations 110, the one or more cameras 120, the one or more display units 130, and/or the processing server 140 are all separate devices interconnected via a wired connection and/or a wireless connection and/or with interactions between the devices occurring over one or more networks. In these embodiments, the one or more smart display stations 110 transmit the detections, determinations, and/or measurements made by the one or more smart display stations 110 to the processing server 140, the one or more cameras 120 transmit the one or more images to the processing server 140, and the processing server 140 transmits any outputs to the one or more display units 130.

### Exemplary Computing Environment

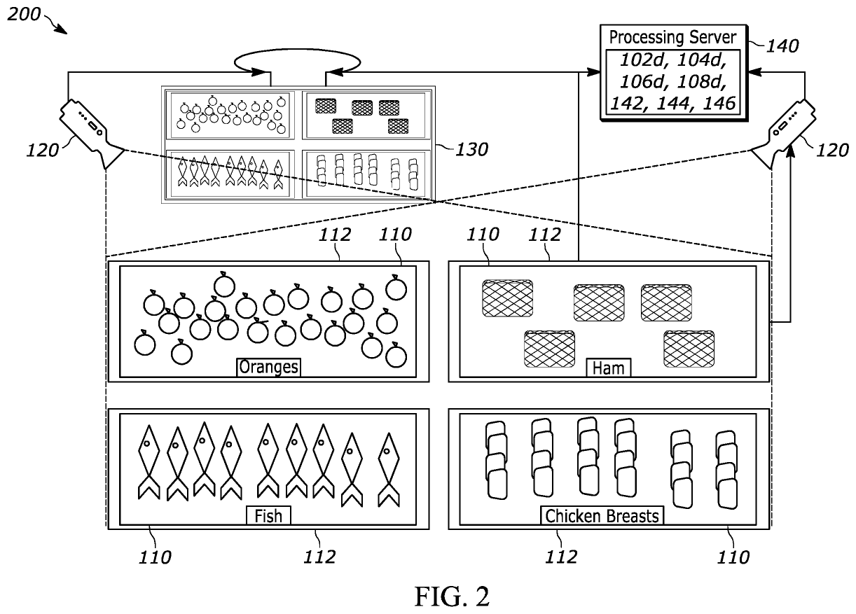

FIG. 2 depicts a diagram of an exemplary environment 200. The exemplary environment 200 may include one or more smart display stations 110, one or more cameras 120, one or more display units 130, and/or a processing server 140.

The one or more smart display stations 110 may interact with the one or more cameras 120 (as illustrated in FIGS. 1B and 2). In some embodiments, the one or more smart display stations 110 may send a signal to the one or more cameras 120, the signal being triggered by a detection in a change in weight from the electronic scale 112. Additionally or alternatively, the signal may come from another sensor and/or electronic device and/or the one or more cameras 120 and/or a component of the one/or cameras. This signal may in turn cause the one or more cameras 120 to capture one or more images of the one or more smart display stations 110.

The one or more smart display stations 110 may also interact with the processing server 140 (as illustrated in FIGS. 1B and 2). In some embodiments, the one or more smart display stations 110 may send a signal to the processing server 140, the signal being triggered by a detection in a change in weight from the electronic scale 112. Additionally or alternatively, the signal may come from another sensor and/or electronic device and/or the one or more cameras 120 and/or a component of the one or more cameras 120. In these embodiments, the one or more cameras 120 may continuously capture one or more images of the one or more smart display stations 110 (e.g., by video recording, by real-time video streaming, by real-time video broadcasting, etc.), and the signal may be used by the processing server 140 to determine a point in time to select a particular image from the one or more captured images to process.

The one or more smart display stations 110 may interact with the one or more cameras 120 and/or the processing server 140 via a wired connection (e.g., wires, fiber optic cables, etc.) and/or a wireless connection (Wi-Fi, Bluetooth, etc.). In some embodiments, the interaction may occur over one or more networks (e.g., the internet, a local area network (LAN), a metropolitan area network (MAN), a wide area network (WAN), a wired network, a Wi-Fi network, a cellular network, a wireless network, a private network, a virtual private network (VPN), etc.). In these embodiments, one or more network connections may be established by the one or more network adapters 106a of the one or more smart display stations 110, the one or more network adapters 106b of the one or more cameras 120, the one or more network adapters 106c of the one or more display units 130, and/or the one or more network adapters 106d of the processing server 140.

The electronic scale 112 may continuously monitor the weight of objects placed atop the one or more smart display stations 110. When an object is placed upon or removed from a smart display station 110, the electronic scale 112 of the smart display station 110 may detect a change in weight caused by the addition or removal of the object. For example, a smart display station 110 may hold 20 pounds of chicken breasts and the electronic scale 112 may continue to detect the weight of 20 pounds in predetermined time periods (e.g., 10 milliseconds). 5 pounds of chicken breasts may be added to the smart display station 110 and the electronic scale 112 may detect the new weight of chicken breasts to be 25 pounds.

In some embodiments, the electronic scale 112 may use various techniques to determine changes in weight. For example, the electronic scale 112 coupled to the one or more processors 102a may wait until, over the course of a predetermined time period, a new constant weight value is measured as this new constant weight value may be indicative of an object either placed onto or removed from the smart display station 110 (e.g., an object is no longer being removed from the smart display station 110). As another example, the electronic scale 112 coupled to the one or more processors 102a may detect a change in weight as a function of time to determine a period of time when the continuous rate of change is 0 (e.g., the rate of change has stopped and the weight is a constant value). As another example, the electronic scale 112 coupled to the one or more processors 102a may detect spikes in the changes in weight (e.g., the electronic scale 112 suddenly measures a sharp increase due to a user exerting a downward force on the smart display station 110 as they extract the object, the scale suddenly measures a sharp decrease due to the sudden removal of a portion of the object, etc.) and may follow a protocol to ignore these spikes in the measurements (e.g., based on the measured value exceeding a set threshold) to accurately assess the final change in weight. The electronic scale 112 may use any combination of these techniques and/or other techniques not described herein to determine the change in weight of the object. Upon measuring the new weight value, the smart display station 110 may calculate the difference between the newly measured weight and the previously measured weight to determine the weight of the object (Aw). In some embodiments, multiple objects may be added and/or removed too close in time for the smart display station 110 to individually distinguish. In these embodiments, the weight of the objects may be estimated (e.g., by average weight, median weight, etc.) as they are identified by the system and stored in the one or more memories 104b of the smart display station 110.

Once the processing server 140 has received (i) the detection of a change in weight of the smart display station 110, (ii) the change in weight measured by the electronic scale 112, and/or (iii) the one or more images from the one or more cameras 120, the processing server 140 may process the one or more images to: (i) detect one or more objects in the one or more images that caused the detected change in weight; (ii) identify the one or more objects; and/or (iv) associate the detected and/or measured change in weight with the one or more objects to determine a transaction value associated with the one or more objects.

In some embodiments, the one or more display units 130 may display a real-time display 132 of the one or more smart display stations 110. In these embodiments, the processing server 140 may transmit the one or more processed images to the display units 130 in addition to any determined data (e.g., the measured weight of the one or more objects, identifying information of the one or more objects, the transaction value of the one or more objects, etc.). In the real-time display 132, the determined data may be overlaid atop of the one or more images to illustrate the association between the determined data and the one or more objects in the one or more images. For example, the weight of an object, name of the object, and/or the transaction value of the object may be overlaid on the image adjacent to the placement of the object.

In some other embodiments, the one or more display units 130 may display a virtual display 134 of the one or more smart display stations 110. In these embodiments, the processing server 140 may generate a virtual simulation of the one or more displays stations 110 and all identifiable objects detected within the one or more images of the one or more cameras 120. The virtual simulation may be a two dimensional representation or a three dimensional representation. In some embodiments, the virtual simulation may be generated using three dimensional object reconstruction, three dimensional modeling, and/or three dimensional motion capture.

### Exemplary Image Processing

The processing server 140 may process the one or more images captured by the one or more cameras 120. Processing the one or more images may include: (i) selecting a single image from a multitude of images, (ii) determining the quality of the one or more images, and/or (iii) identifying and/or recognizing one or more objects within the one or more images.

In some embodiments, the one or more cameras 120 may capture more than one image (e.g., by capturing burst images, by video recording, by streaming real-time video, by broadcasting real-time video, etc.). In these embodiments, the processing server 140 may select a single image from a plurality of images. Selection of the images may be done naively (e.g., by selecting the first image captured at a time interval, by selecting an image from the plurality of images at random, etc.) and/or it may be performed via some algorithm or process (e.g., by determining the quality of the image, as described below, etc.).

The processing server 140 may determine the quality of an image via several different methods. In some embodiments, the processing server 140 may utilize any of the following focus measure operators and their accompanying algorithms to determine the focus of the image: gradient-based operators (GRA*), Laplacian-based operators (LAP*), wavelet-based operators (WAV*), statistics-based operators (STA*), discrete cosine transform (DCT) based operators (DCT*), and/or the like. In these embodiments, the processing server 140 may use any of the foregoing operators and/or algorithms to measure the degree of focus of either a whole image or an image pixel. In some other embodiments, the processing server 140 may use machine learning, neural networks, deep learning, and/or other artificial intelligence techniques to determine if objects in the image are capable of being identified and/or recognized, as described below (it should be noted that the processing server 140 need not perform the image identification and/or recognition to determine image quality). The processing server 140 is not limited to using these foregoing techniques, and other systems, methods, and/or techniques of determining the quality of the image are contemplated.

If the quality of the image falls below a set threshold value (and/or objects in the image cannot be identified and/or recognized), the processing server 140 may select a different image from the plurality of images to determine the quality of this newly selected image and/or send instructions to the one or more cameras 120 to capture another image and/or plurality of images. This process may repeat until an image of sufficient quality (e.g., an image that meets the set threshold value) has been selected and obtained by the processing server 140.

The processing server 140 may select an image using any of the foregoing methods, systems and techniques. Additionally or alternatively, the processing server 140 may select the image based upon the highest relative quality when the image is compared to the other obtained images. In some other embodiments, the processing server 140 may not select a single image, and may instead use the plurality of images for further processing and/or analysis.

The processing server 140 may identify and/or recognize one or more objects within the one or more images via a number of methods including, but not limited to: (i) image categorization, image classification, image recognition, and/or image identification techniques which may include query by image content (QBIC), optical character recognition (OCR), pattern and/or shape recognition, histogram of oriented gradients (HOG) and/or other object detection methods, one dimensional bar code scanning, two dimensional bar code (or “quick response code” (QR)) scanning, and/or the like; (ii) three dimensional (3D) reconstruction and/or 3D object identification which may include 3D laser scanning, photogrammetric captures, and/or the like; (iii) machine learning techniques which may include gradient boosting, neural networks, deep learning, linear regression, polynomial regression, logistic regression, support vector machines, decision trees, random forests, nearest neighbors, and/or any other suitable machine learning technique.

In some embodiments, the processing server 140 may utilize deep learning and/or neural networks to analyze the one or more images. In these embodiments the processing server 140 may employ an architecture composed of various types of artificial neural networks (ANNs). In particular, the architecture may include a convolutional neural network (CNN), a recurrent neural network (RNN), and/or at least one fully connected neural network.

Each of the ANNs may be trained with training data relevant to the desired context or application, using various backpropagation or other training techniques. In particular, a set of training images, along with corresponding training labels, may be input into the corresponding ANN, which may analyze the inputted data to arrive at a prediction. By recursively arriving at predictions, comparing the predictions to the training labels, and minimizing the error between the predictions and the training labels, the corresponding ANN may train itself according to the input parameters. In some embodiments, the trained ANN may be configured with a set of corresponding edge weights which enable the trained ANN to analyze new image data.

In some embodiments, once the ANN has been trained, the ANN may be tested by another set of images separate from the training set. The testing data may have the same or similar labels as the training set, but may comprise images not yet analyzed by the trained ANN to determine the accuracy of the architecture.

The processing server 140 is not limited to using these foregoing techniques, and other systems, methods, and/or techniques of identifying and/or recognizing the objects in the one or more images are contemplated.

### Exemplary Implementation

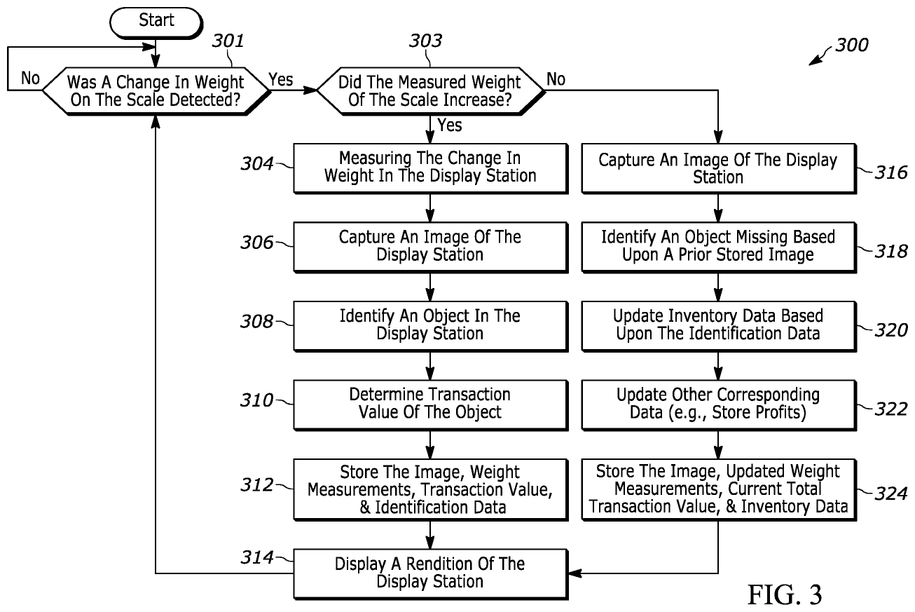

FIG. 3 depicts an exemplary method 300 for implementing the automated weight measuring and inventory management of consumer goods. In some aspects, the method 300 may correspond to and/or be implemented by components, apparatuses, devices, and/or systems described in FIGS. 1A-2.

The processes, methods, software, and/or computer-executable instructions included within the method 300 may be, or may include, one or more executable programs and/or portions of one or more executable programs for execution by one or more processors 102. The one or more executable programs may be embodied in software or instructions stored on a non-transitory computer-readable storage medium or disk associated with the one or more processors 102. Further, although the example method 300 is described with reference to the flowchart illustrated in FIG. 3, many other methods of implementing the automated weight measuring and inventory management of consumer goods may alternatively be used. For example, the order of execution of the blocks may be changed, and/or some of the blocks described may be changed, eliminated, or combined.

Additionally, or alternatively, any or all of the blocks may be implemented by one or more hardware circuits (e.g., discrete and/or integrated analog and/or digital circuitry, an application specific integrated circuit (ASIC), a programmable logic device (PLD), a field programmable gate array (FPGA), a field programmable logic device (FPLD), a logic circuit, etc.) structured to perform the corresponding operation without executing software or firmware.

The exemplary method 300 of FIG. 3 may begin with the electronic scale 112 of the one of the one or more smart display stations 110 detecting a change in weight of the consumer goods atop the smart display station 110 (301). If a change in weight has not been detected, the method 300 may return to the start the method 300 at block 301.

The electronic scale 112 of the smart display station 110 may continuously monitor the weight of the consumer goods over a set time interval. Further, if the weight returns to a previously measured weight at any point during the method 300, the method 300 may return to block 301 as this return in weight may be indicative of any change in the consumer goods atop the smart display station 110 (e.g., either the addition or removal of a consumer good) that has been undone.

In some embodiments, the electronic scale 112 may measure either an increase or decrease in weight (303). In the embodiments where the electronic scale 112 has measured an increase in weight, the method 300 may proceed to block 304. In the embodiments where the electronic scale 112 has measured a decrease in weight, the method 300 may proceed to block 316.

If the electronic scale 112 has determined the change in weight is an increase in weight, the method 300 may proceed with the electronic scale 112 measuring the change in weight (304). This measurement may be performed by taking the difference between the newly measured weight after the detected change in weight and a previously measured weight before the detected change in weight. This new measurement may later be associated with one or more consumer goods added to the smart display station 110 to determine the weight of those one or more consumer goods.

The method 300 may proceed with the one or more cameras 120 capturing one or more images of the smart display station 110 (306). In some embodiments, the one or more cameras 120 may be instructed to capture the one or more images upon the electronic scales 112 detecting a change in weight. In some other embodiments, the one or more cameras 120 may be instructed to capture the one or more images upon the one or more cameras 120 detecting an object entering a field of view of the one or more cameras 120. In some other embodiments, the one or more cameras 120 may be instructed to capture the one or more images upon the triggering of some other electronic sensor and/or device (e.g., a motion capture sensor, a lidar sensor, etc.). In some other embodiments, the one or more cameras may be instructed to capture the one or more images continuously (e.g., via a video recording, a real-time video stream, a real-time video broadcast, etc.).

The method 300 may proceed with the processing server 140 identifying one or more newly added objects in the one or more images captured by the one or more cameras 120 (308). Upon receiving the detections, determinations, and/or measurements from the one or more smart display stations 110 (and/or their components) and/or the one or more images from the one or more cameras 120, the processing server 140 may process the one or more images, as described above (e.g., to (i) select a single image from a multitude of images, (ii) determine the quality of the one or more images, and/or (iii) identify and/or recognize one or more newly added objects within the one or more images). In some embodiments, the one or more newly added objects may be identified by comparing the one or more images to a set of previously captured images and identifying the one or more objects not present in the set of previously captured images.

The method 300 may proceed with the processing server 140 determining a transaction value of the one or more identified objects (310). This determination may be made by (i) associating the measured change in weight to the one or more identified objects, (ii) determining the price per pound value of the one or more identified objects, and (iii) calculating the transaction value of the one or more identified objects based upon the measured change in weight and the price per pound value of the one or more identified objects.

In the embodiments where more than one object is identified, an estimated weight of each kind of object may be used in the calculation of the transaction values, as described above. For example, if 2 bananas, 3 oranges, and 2 apples are identified on a smart display station 110, and the average weight of bananas is 0.82 pounds, the average weight of the oranges is 0.79 pounds, and the average weight of apples is 0.74 pounds, the processing server 140 may make an initial estimation that the weight of the 2 bananas is 1.64 pounds, the weight of the oranges is 1.58 pounds, and the weight of the apples is 1.48 pounds. However, if the total estimated weight (in this example, 4.70 pounds) exceeds the measured change in weight (e.g., 4.52 pounds), the processing server 140 may re-estimate the weights of the identified objects (e.g., based upon median weights of the objects, based upon root mean square weights of the objects, based upon tailored estimated weights derived by the perceived size of the objects, etc.) until the estimated weights of the identified objects satisfies a threshold error rate when compared to the measured weight of the objects.

The method may proceed with the processing server 140 storing: (i) the detections, determinations, and/or measurements made by the one or more smart display stations 110, (ii) the one or more images, (iii) the identification data of the one or more identified objects, (iv) the weights and/or weight estimates of the one or more identified objects, and/or (v) the transaction value associated with the one or more identified objects to the one or more memories 104d of the processing server 140 (312).

The method may proceed with the one or more display units 130 displaying a real-time rendition of the one or more smart display stations 110 (314). The rendition may be either a real-time display 132 or a virtual display 134 of the one or more smart display stations 110 and may also overlay any of the stored data, as described above. In the embodiments where a virtual display 134 is displayed, the virtual display 134 generated may be updated by adding the one or more identified objects that have been added to the smart display station 110

The method 300 may repeat indefinitely or may repeat over the course of a set time period (e.g., operating hours of a store) by returning back to block 301.

If the electronic scale 112 determines the change in weight is a decrease in weight, the method 300 may proceed with the one or more cameras 120 capturing one or more images of the smart display station 110 (316). Similarly, to block 306, the one or more cameras 120 may be instructed to capture the one or more images (i) upon the electronic scales 112 detecting a change in weight, (ii) upon the one or more cameras 120 detecting an object entering a field of view of the one or more cameras 120, and/or (iii) upon some electronic sensor and/or device triggering. In some other embodiments, the one or more cameras may be instructed capture the one or more images continuously.

Once the image has been captured, the processing server 140 may compare the one or more images to a set of prior images to determine if one or more objects have been removed from the smart display station 110 and which object(s) have been removed (318). This may be accomplished by accessing the data stored (e.g., at block 312) and using any of the image analysis techniques described above. Additionally or alternatively, in some embodiments, the object removed from the smart display station 110 may still be visible and/or captured by the one or more cameras 120 (e.g., a customer is holding a slab of beef, etc.). In these embodiments, the processing server 140 may utilize the same and/or similar processes described above (e.g., at block 308) to analyze the one or more images to determine the one or more objects removed from the smart display station 110.

Once the one or more removed objects have been identified, the associated data attached to the one or more removed objects (e.g., (i) the detections, determinations, and/or measurements, (ii) the one or more stored images, (iii) the identification data, (iv) the weights and/or weight estimates of the one or more identified objects, (v) the transaction value, etc.) may be retrieved from the one or more memories 104d of the processing server 140. This retrieved data may then be used to update a list of the store's inventory (320). Based on image tracking and/or corroborating data from other systems (e.g., checkout, inventory shelf stock, etc.), the processing server 140 can determine if the one or more objects removed from the smart display station 110 have been purchased by a customer or returned to storage. If the processing server 140 determines that the one or more objects were returned to storage, then the inventory list may remain unchanged. However, if the processing server 140 determines that the one or more objects were purchased by a customer, then the inventory list may be updated by removing the one or more objects from the list and updating all other corresponding information (e.g., store profits, the transaction value on display at the one or more display units 130, etc.) (322).

The method may proceed with the one or more display units 130 displaying a real-time rendition of the one or more smart display stations 110 (314). The rendition may be either a real-time display 132 or a virtual display 134 of the one or more smart display stations 110 and may also overlay any of the stored data, as described above. In the embodiments where a virtual display 134 is displayed, the virtual display 134 generated may be updated by removing the one or more identified objects that have been removed from the smart display station 110.

The method 300 may repeat indefinitely or may repeat over the course of a set time period (e.g., operating hours of a store) by returning back to block 301.

### Exemplary Method

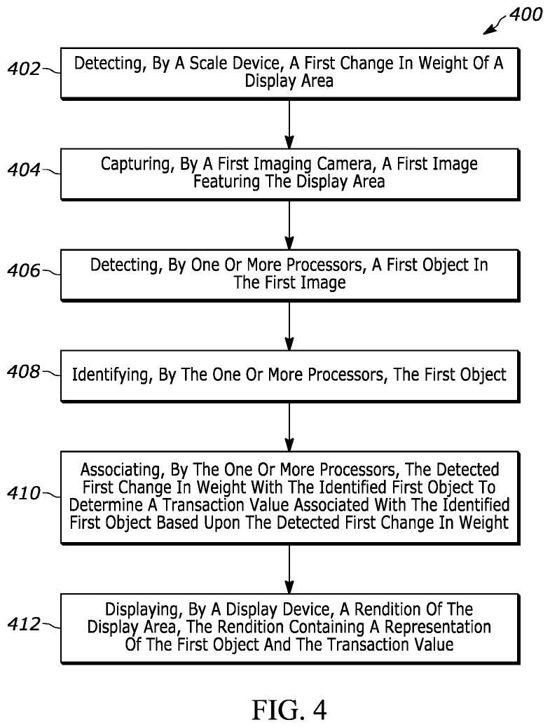

FIG. 4 depicts an exemplary method 400 for automated weight measuring and inventory management of consumer goods. The method 400 may employ any of the devices, systems, and/or systems described herein with respect to FIGS. 1A-3.

The method 400 may begin at block 402 by detecting, by a scale device (e.g., the electronic scale 112), a first change in weight of a display area (e.g., the one or more smart display stations 110).

The method 400 may proceed to block 404 by capturing, by a first imaging camera (e.g., one of the one or more cameras 120), a first image featuring the display area. In some embodiments, the first imaging camera may be triggered to capture one or more images (such as the first image) once the scale device detects the first change in weight. In some other embodiments, the first imaging camera may capture the one or more images at periodic intervals in addition to capturing one or more images when triggered by the scale device. In yet some other embodiments, the first imaging camera may capture one or more images continuously (e.g., a video recording, a real-time video stream, a real-time video broadcast, etc.). In these embodiments, the first image may be selected by the first imaging camera or the processing server 140. In the embodiments, where the detection is performed by the processing server 140, the first imaging camera may transfer the first image (and/or a plurality of images that may contain the first image) to the processing server 140. Further, in these embodiments, the detection trigger of the scale device may also be transferred to the processing server 140.

The method 400 may proceed to block 406 by detecting, by one or more processors (e.g., the one or more processors 102), a first object in the first image. Detecting the first object may be performed by either the first imaging camera or the processing server 140. In some embodiments, detecting the first object may involve pre-processing techniques, such as comparing the first image to one or more prior images (if available) to detect differences between the first image and the one or more prior images. In some other embodiments (such as when no prior images are available), detecting the first object may be performed by image identification and/or recognition, wherein all identifiable objects within the first image, other than the first object, are first identified (e.g., the display area, common inventory stock, signs, etc.) and the portion of the first image not yet identified and/or recognized is the first object. In some other embodiments, some combination of the foregoing techniques and/or portions thereof may be used.

The method 400 may proceed to block 408 by identifying, by the one or more processors, the first object. Identifying the first object may be accomplished by performing image recognition, 3D model reconstruction, and/or machine learning. The identification may be performed by either the first camera or the first processing server 140.

The method 400 may proceed to block 410 by associating, by the one or more processors, the detected first change in weight with the identified first object to determine a transaction value associated with the identified first object based upon the detected first change in weight. The first change in weight may be used to determine the weight of the first object. Further, based on the identification of the first object, if the first object is inventory with a price-per-pound figure, a transaction value of the first object may be calculated and associated with the first object. This calculation may be performed by the first image camera or the processing server 140.

The method 400 may proceed to block 412 by displaying, by a display device (e.g., one of the one or more display units 130), a rendition of the display area, the rendition containing a representation of the first object and the transaction value. The rendition may be a real-time representation (e.g., one of the one or more real-time displays 132) or a virtual representation (e.g., one of the one or more virtual displays 134). The real-time representation may be generated by transmitting the first image (and/or the plurality of images that contains the first image) to the display device for display. The virtual representation may be generated by either the first image camera or the processing server 140 based upon either a two dimensional (2D) or a 3D simulated reconstruction generated based upon the first image and/or one or more other images captured by the first image camera and/or other cameras (e.g., the second image camera). The real-time representation and/or virtual representation may also display the calculated transaction value and/or the weight of the first object.

The weight of the first object, the transaction value of the first object, the identification of the first object, the first image, etc. may be stored in one or more memories (e.g., the one or more memories 104) of the first imaging camera or the processing server 140. These stored values may be used to generate an inventory list (based upon the identifications), a total transactional value on display, and a current total weight of the display area.

When a customer takes an object from the first display area, the system (e.g., the first image camera, scale device, and/or processing server 140) may be able to determine the object taken from the display area and (i) remove it from the inventory list, (ii) deduct its transactional value from the total transactional value on display, and (iii) subtract its weight from the current total weight of the display area.

Similarly, when another object is placed onto the display area, this new object may have its weight detected, image taken, be identified, and have a transactional value associated it by the first imaging camera or the processing server 140 as described above.

When multiple objects are placed onto the display area simultaneously, the system may make an estimation as to each of the new objects' weight based on the previously stored weight and the newly detected weight and other similarly registered weights of similar items (e.g., the average weight, median weight, etc.) so long as the estimated weights do not exceed the newly detected weight plus the previously stored weight.

In some embodiments, more than one camera is used (e.g., a second imaging camera, a third imaging camera, etc., each being one of the one or more cameras 120).

In some embodiments, the one or more images captured by the one or more cameras 120 are captured when the object enters the field of view of the one or more cameras. In these embodiments, image identification and/or recognition may be performed before a detection in a change in weight and the weight of the object may be estimated as described above. The object may be labelled via motion capture principles between multiple images, and the previously estimated weight may be replaced with an accurate weight when the object is placed on the scale device and the change in weight of the display area is measured.

In some embodiments, to avoid miscalculations in the measurements of weight, the scale device may be set to only detect changes in weight of the display area during steady states. The steady state may be a threshold time window and/or a threshold weight increase. Further, detecting the change in weight may include removing spurious weight values.

The method 400 may have more or less or different steps and/or may be performed in a different sequence.

### Additional Considerations

Although the text herein sets forth a detailed description of numerous different embodiments, it should be understood that the legal scope of the invention is defined by the words of the claims set forth at the end of this document. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, some embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more modules of a computer system (e.g., a processor or a group of processors) may be configured by software (e.g., an application or application portion) as a module that operates to perform certain operations as described herein.

In various embodiments, a module may be implemented mechanically or electronically. Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules are temporarily configured (e.g., programmed), each of the modules need not be configured or instantiated at any one instance in time. For example, where the modules comprise a general-purpose processor configured using software, the general-purpose processor may be configured as respective different modules at different times. Software may accordingly configure a processor, for example, to constitute a particular module at one instance of time and to constitute a different module at a different instance of time.

Modules may provide information to, and receive information from, other modules. Accordingly, the described modules may be regarded as being communicatively coupled. Where multiple of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may, at a later time, access the memory device to retrieve and process the stored output. Modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

Unless specifically stated otherwise, discussions herein using words such as “receiving,” “analyzing,” “generating,” “creating,” “storing,” “deploying,” “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information. Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other.

As used herein any reference to “some embodiments” means that a particular element, feature, structure, or characteristic described in connection with the embodiment may be included in at least one embodiment. The appearances of the phrase “some embodiments” in various places in the specification are not necessarily all referring to the same embodiment. In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

This detailed description is to be construed as exemplary only and does not describe every possible embodiment, as describing every possible embodiment would be impractical, if not impossible. One could implement numerous alternate embodiments, using either current technology or technology developed after the filing date of this application. Upon reading this disclosure, those of skill in the art will appreciate still additional alternative structural and functional designs for system and a method for assigning mobile device data to a vehicle through the disclosed principles herein.

Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein. It is therefore intended that the foregoing detailed description be regarded as illustrative rather than limiting, and that it be understood that it is the following claims, including all equivalents, that are intended to define the spirit and scope of this invention.

What is claimed:

1. A method for weighing consumer goods, the method comprising:
detecting, by a scale device, a first change in weight of a display area;
capturing, by a first imaging camera, a first image featuring the display area;
detecting, by one or more processors, a first object in the first image;
identifying, by the one or more processors, the first object;
associating, by the one or more processors, the detected first change in weight with the identified first object to determine a transaction value associated with the identified first object based upon the detected first change in weight; and
displaying, by a display device, a rendition of the display area, the rendition containing a representation of the first object and the transaction value associated with the identified first object.

2. The method of claim 1, wherein the transaction value associated with the identified first object is based upon at least one of a weight of the identified first object, a price of the identified first object, or a first object identifier.

3. The method of claim 1, wherein identifying the first object comprises:
identifying, by the one or more processors, one or more features of the detected first object in the image; and
identifying, by the one or more processors, the first object based on the one or more features.

4. The method of claim 1, wherein identifying the first object comprises:
segmenting, by the one or more processors, a portion of the first image corresponding to the detected first object;
communicating, by the one or more processors, the segmented portion of the first image to a trained machine learning model; and
identifying, by the one or more processors, the first object using the trained machine learning model.

5. The method of claim 4, wherein the trained machine learning model is a deep learning neural network.

6. The method of claim 1, wherein displaying the rendition of the display area comprises:
displaying a real-time captured image of the detected first object and displaying the transaction value associated with the identified first object with the real-time captured image of the detected first object.

7. The method of claim 6, further comprising:
capturing the real-time captured image of the detected first object from the first imaging camera.

8. The method of claim 6, further comprising:
capturing the real-time captured image of the detected first object by a second imaging camera.

9. The method of claim 1, wherein displaying the rendition of the display area comprises:
displaying a virtualized rendition of the display area, the virtualized rendition comprising a virtualized rendition of the detected first object and displaying the transaction value associated with the identified first object in an associated manner with the virtualized rendition of the detected first object.

10. The method of claim 1, further comprising:
storing, by the one or more processors, one or more of data identifying the object, the first image, the representation of the first object, or the transaction value associated with the identified first object.

11. The method of claim 10, further comprising:
detecting, by the scale device, a second change in weight;
upon detecting the second change in weight, capturing, by the first imaging camera, a second image;
detecting, by the one or more processors, a second object in the second image, the second object not being in the first image;
identifying, by the one or more processors, the second object;
associating, by the one or more processors, the detected second change in weight with the identified second object to determine a transaction value associated with the identified second object based upon the detected first change in weight; and
displaying, by the display device, a rendition of the display area, the rendition containing a representation of the second object and the transaction value associated with the identified second object.

12. The method of claim 11, wherein capturing the second image occurs in response to detecting a presence of the second object entering a field of view (FOV) of the first imaging camera.

13. The method of claim 1, wherein detecting the first change in weight of the display area comprises:
detecting the first change in weight of the display area after a steady state condition is satisfied.

14. The method of claim 13, wherein the steady state condition is one or more of a threshold time window or a threshold amount of weight increase.

15. The method of claim 13, wherein detecting the first change in weight of the display area after the steady state condition comprises removing spurious measured weight values from the scale device.

16. A system for weighing consumer goods, the system comprising:
a scale device,
wherein the scale device detects a first change in weight of a display area;
a first imaging camera,
wherein the first imaging camera captures a first image featuring the display area;
one or more processors,
wherein the one or more processors:
(i) detect the first object in the first image,
(ii) identify the first object, and
(iii) associate the detected first change in weight with the identified first object to determine a transaction value associated with the identified first object based upon the detected first change in weight; and
a display device,
wherein the display device displays a rendition of the display area, the rendition containing a representation of the first object and the transaction value associated with the identified first object.

17. The system of claim 16, wherein:
the one or more processors are further caused to:
(i) identify one or more features of the detected first object in the image,
(ii) identify the first object based on the one or more features,
(iii) segment a portion of the first image corresponding to the detected first object,
(iv) communicate the segmented portion of the first image to a trained machine learning model, and
(v) identify the first object using the trained machine learning model, the trained machine learning model being a deep learning neural network.

18. The system of claim 16, wherein:
the scale device is further caused to detect a second change in weight;
the first imaging camera is further caused to capture a second image upon the detection of the second change in weight;
the one or more processors are further caused to:
(i) store one or more of data identifying the object, the first image, the representation of the first object, or the transaction value associated with the identified first object;
(ii) detect a second object in the second image, the second object not being in the first image,
(iii) identify the second object, and
(iv) associate the detected second change in weight with the identified second object to determine a transaction value associated with the identified second object based upon the detected first change in weight; and
the display device is further caused to display a rendition of the display area, the rendition containing a representation of the second object and the transaction value associated with the identified second object.

19. A tangible, non-transitory computer-readable medium storing executable instructions for weighing consumer goods, the instructions, when executed by one or more processors of a computer system, cause the computer system to:
receive a first image and a detected first change in weight of a display area;
detect a first object in the first image;
identify the first object;
associate the detected first change in weight with the identified first object to determine a transaction value associated with the identified first object based upon the detected first change in weight;
generate a rendition of the display area, the rendition containing a representation of the first object and the transaction value associated with the identified first object; and
transmit the rendition to a display device.

20. The tangible, non-transitory computer-readable medium of claim 19, wherein the executable instructions further cause the computer system to:
identify one or more features of the detected first object in the image,
identify the first object based on the one or more features,
segment a portion of the first image corresponding to the detected first object,
communicate the segmented portion of the first image to a trained machine learning model, and
identify the first object using the trained machine learning model, the trained machine learning model being a deep learning neural network.
